(19) United States
(12) Patent Application Publication
(10) Pub. No.: US 2016/0212622 A1
(43) Pub. Date: Jul. 21, 2016

(54) ENHANCED BACK-TO-BACK SECURITY PROCEDURE HANDLING

(71) Applicant: QUALCOMM Incorporated, San Diego, CA (US)

(72) Inventors: Vagish GUPTA, Hyderabad (IN); Sitaramanjaneyulu Kanamarlapudi, San Diego, CA (US); Chetan Gopalakrishnan Chakravarthy, San Diego, CA (US); Liangchi Hsu, San Diego, CA (US); Ansah Ahmed Sheik, Hyderabad (IN); Adarsh Kumar Jinnu, Hyderabad (IN)

(21) Appl. No.: 14/831,654

(22) Filed: Aug. 20, 2015

Related U.S. Application Data
(60) Provisional application No. 62/105,584, filed on Jan. 20, 2015.

(51) Int. Cl. H04W 12/10

(52) U.S. Cl. CPC H04W 12/10

(57) ABSTRACT

Aspects of the disclosure provide for a method of efficiently implementing security configurations for multiple domains between a network entity and a UE in a wireless system. For instance, this disclosure provides for a network entity sending to a UE a first security mode command for a first domain, receiving a first security mode complete message in response to the first security mode command, and sending a second security mode command for a second domain. In an aspect, the second security mode command is sent in response to receiving the first security mode complete message. In an aspect, the UE does not receive a RLC acknowledgement. In another aspect, the UE saves the second security mode command until it receives the RLC acknowledgement. In an aspect, the network entity sends the second security mode command in response to receiving a message protected with first security procedure parameters.

### CROSS-REFERENCE TO RELATED APPLICATION(S)

This application claims priority to U.S. Provisional Application Ser. No. 62/105,584, entitled, “ENHANCED BACK-TO-BACK SECURITY PROCEDURE HANDLING,” and filed on Jan. 20, 2015, which is assigned to the assignee hereof and hereby expressly incorporated by reference herein in its entirety.

### BACKGROUND

Aspects of the present disclosure relate generally to wireless communication systems, and more particularly, to implementation of security procedures with domains in a wireless communications system.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA) and High Speed Uplink Packet Access (HSUPA), which provide higher data transfer speeds and capacity to associated UMTS networks.

In a W-CDMA system, a user equipment (UE) is required to start security procedures for each domain (e.g., a core network including a circuit-switched domain and/or a packet-switched domain) before performing or completing high-level signaling or user services in each of the domains. Such procedures include requirements related to integrity protection that cause a UE to perform security with different domains in back-to-back procedures.

Additionally, the network entity (such as a base station) performing the security procedure does not have an efficient way of determining whether the UE has concluded establishing a particular security procedure. This may lead to inefficiencies in establishing security parameters for multiple domains, as the network entity has no efficient way to determine whether it can start establishing security parameters for the next domain.

Thus, improvements in control of security establishment procedures for multiple domains are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure provides for a method of efficiently implementing security configurations for multiple domains between a network entity and a UE in a wireless system. For instance, this disclosure provides for a network entity sending to a UE a first security mode command for a first domain, receiving a first security mode complete message from the UE in response to the first security mode command, and sending a second security mode command for a second domain to the UE. In an aspect, the second security mode command is sent in response to receiving the first security mode complete message. In an aspect, the network entity does not send a RLC acknowledgement and/or the UE does not receive a RLC acknowledgement. In an aspect, the network entity sends the second security mode command in response to receiving a message protected with first security procedure parameters.

In an aspect, the disclosure provides a method implemented by a UE for implementing a security mode configuration in a wireless system. For instance, this disclosure provides for a UE receiving a first security mode command for a first domain sent by a network entity in the wireless system. In an aspect, the disclosure provides for sending a first security mode complete message in response to receiving the first security mode command and receiving a second security mode command for a second domain. In an aspect, the second security mode command is received in response to the sending of the first security mode complete message. In an aspect, the UE does not receive a RLC acknowledgement. In another aspect, the UE saves the second security mode command until it receives the RLC acknowledgement. In an aspect, the UE saves the second security mode command in response to sending a message protected with first security procedure parameters.

In another aspect, the disclosure provides for an apparatus for implementing a security mode configuration in a wireless system. For instance, this disclosure provides for an apparatus that includes at least one processor and a memory coupled to the at least one processor. In an aspect, the processor is configured to send to a UE a first security mode command for a first domain, receive a first security mode complete message from the UE in response to the first security mode command, and send a second security mode command for a second domain.

In another aspect, the disclosure provides an apparatus for implementing a security mode configuration in a wireless system. For instance, this disclosure provides for an apparatus that includes at least one processor and a memory coupled to the at least one processor. In an aspect, the at least one processor is configured to receive a first security mode command for a first domain sent by a network entity in the wireless system, send a first security mode complete message in response to receiving the first security mode command and receive a second security mode command for a second domain.

In another aspect, the disclosure provides for an apparatus for implementing a security mode configuration in a wireless system. For instance, this disclosure provides for means for sending to a UE a first security mode command for a first domain, means for receiving a first security mode complete message from the UE in response to the first security mode command, and means sending a second security mode command for a second domain to the UE.

In another aspect, the disclosure provides an apparatus for implementing a security mode configuration in a wireless system. For instance, this disclosure provides for means for receiving a first security mode command for a first domain sent by a network entity in the wireless system, means for sending a first security mode complete message in response to receiving the first security mode command and means for receiving a second security mode command for a second domain.

In an aspect, the disclosure provides for a computer-readable medium executable by at least one processor for implementing a security mode configuration in a wireless system. For instance, this disclosure provides for code for sending to a UE a first security mode command for a first domain, code for receiving a first security mode complete message from the UE in response to the first security mode command, and code for sending a second security mode command for a second domain to the UE.

In an aspect, the disclosure provides for a computer-readable medium executable by at least one processor for implementing a security mode configuration in a wireless system. For instance, this disclosure provides for code for receiving a first security mode command for a first domain sent by a network entity in the wireless system, code for sending a first security mode complete message in response to receiving the first security mode command, and code for receiving a second security mode command for a second domain.

These and other aspects of the disclosure will become more fully understood upon a review of the detailed description, which follows.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIG. 1 is a block diagram illustrating an example communications network including a base station in communication with a user equipment and including one or more components for implementing security configurations for multiple domains between the base station and the UE.

FIG. 2A is a flow diagram illustrating an example method of implementing security mode configurations for multiple domains.

FIG. 2B is a flow diagram illustrating an example method of implementing security mode configurations for multiple domains.

FIG. 3A is a flow diagram illustrating an example method of implementing security mode configurations for multiple domains.

FIG. 3B is a flow diagram illustrating an example method of implementing security mode configurations for multiple domains.

FIG. 4A is a flow diagram illustrating an example method of implementing security mode configurations for multiple domains.

FIG. 4B is a flow diagram illustrating an example method of implementing security mode configurations for multiple domains.

FIG. 5 is a signaling diagram illustrating an example signaling flow associated with implementing security mode configurations for multiple domains.

FIG. 6 is a flow diagram illustrating an example method of implementing security mode configurations for multiple domains.

FIG. 7 is a flow diagram illustrating an example method of implementing security mode configurations for multiple domains.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware, firmware, and/or software, and may be divided into other components.

The present disclosure provides for implementation of security mode configurations for multiple domains in a user equipment (UE) in a wireless network. A domain, as used herein, includes a core network domain such as a circuit-switched domain and/or a packet-switched domain. The circuit-switched domain may include a circuit-switched network used for a voice call. The packet-switched domain may include an interconnected, packet-switched computer network, including the Internet, which may be used for a voice call and/or a data call. In a typical wireless network, the UE may be connected to a network entity that provides access to these domains, and some implementations of current communication standards prohibit simultaneous security mode configurations (such as simultaneously establishing security configurations for two separate domains).

According to the present aspects, the UE in the wireless network can adhere to the security requirements by efficiently starting commencement of a second security configuration shortly upon the completion of the first security configuration. The present aspects allow the network entity to send a second security mode command quickly after sending the first security mode command. In an aspect, for example, the network entity can send a second security mode command for a second domain based upon receipt of a security mode complete message for a first domain sent from the UE. In another aspect, for example, the network entity can send a second security mode command for a second domain based upon receipt of a message including first security mode parameters, which indicate that the UE successfully completed the first security mode configuration for the first domain. In contrast, prior solutions require the network and the UE to send, wait for, and/or respond to additional messages, such as the UE waiting for an Radio Link Control (RLC) acknowledgement from the network entity, and/or such as the network entity waiting for Uplink Direct transfer (UDT) message from UE in response to Downlink Direct Transfer (DDT) message sent by the network entity. Thus, the present aspects may reduce undesirable waiting time.

For example, in an aspect, the network entity, such as a base station, can send a security mode command for a circuit-switched (CS) domain. During the configuration process, the UE can send a security mode complete message for the CS domain back to the network entity.

In an aspect, based upon receipt of the security mode complete message for the first domain (CS domain), the network entity can send a second security mode command for security configuration of a second domain (e.g., a packet-switched (PS) domain) to the UE. In other words, for example, the network entity can assume the UE has established the first security mode rather than waiting for receipt of a UDT message in response to a DDT message. Further, in an aspect, for instance, the network entity may send the second security mode command before a first Radio Link Control (RLC) acknowledgement (ACK) associated with the first security mode complete message is received by the UE, or, in another aspect, the network entity does not send the first RLC ACK to the UE and/or the UE does not received the first RLC ACK sent by the network entity. In an aspect, upon receipt of the second security mode command, the UE determines that the configuration for the first domain is complete and can commence security configuration of the second domain. In other words, for example, the UE can assume the network entity has established the first security mode based on receipt of the second security mode command (which is triggered based on the network entity receiving the security mode complete message for the first domain), rather than waiting for the first RLC ACK.

In another aspect, the network entity can send a RLC ACK to the UE to signify the end of the security configuration for the first domain. In this case, the network entity may not determine whether the UE received the RLC ACK. The network entity can send a second security mode command for a second domain, such as a PS domain, upon receipt of the security mode complete message regarding the CS domain. In an aspect, the UE can receive the second security mode command and save the command in memory until it receives the RLC ACK; upon receipt of the RLC ACK, the first configuration is complete and the UE can complete the second security configuration using the stored second security mode command and send a second security complete message regarding the PS domain to the network entity.

In a further aspect, the UE can send a message that includes security parameters associated with the first security mode configuration to the network entity. For example, the message can comprise a measurement report message generated by the UE and packaged using one or more security parameters associated with establishing security for the first domain. According to this aspect, the network entity can receive the message from the UE and determine that the first security configuration is complete, as the message includes parameters associated with the first security configuration. Thus, the network entity can then send a second security mode command for a second domain, such as a PS domain, upon receipt of the measurement report message that uses one or more security parameters associated with establishing security for the first domain.

Accordingly, the present aspects may provide a more efficient method and/or apparatus for controlling security establishment procedures for multiple domains between a UE and a network entity by reducing wait times.

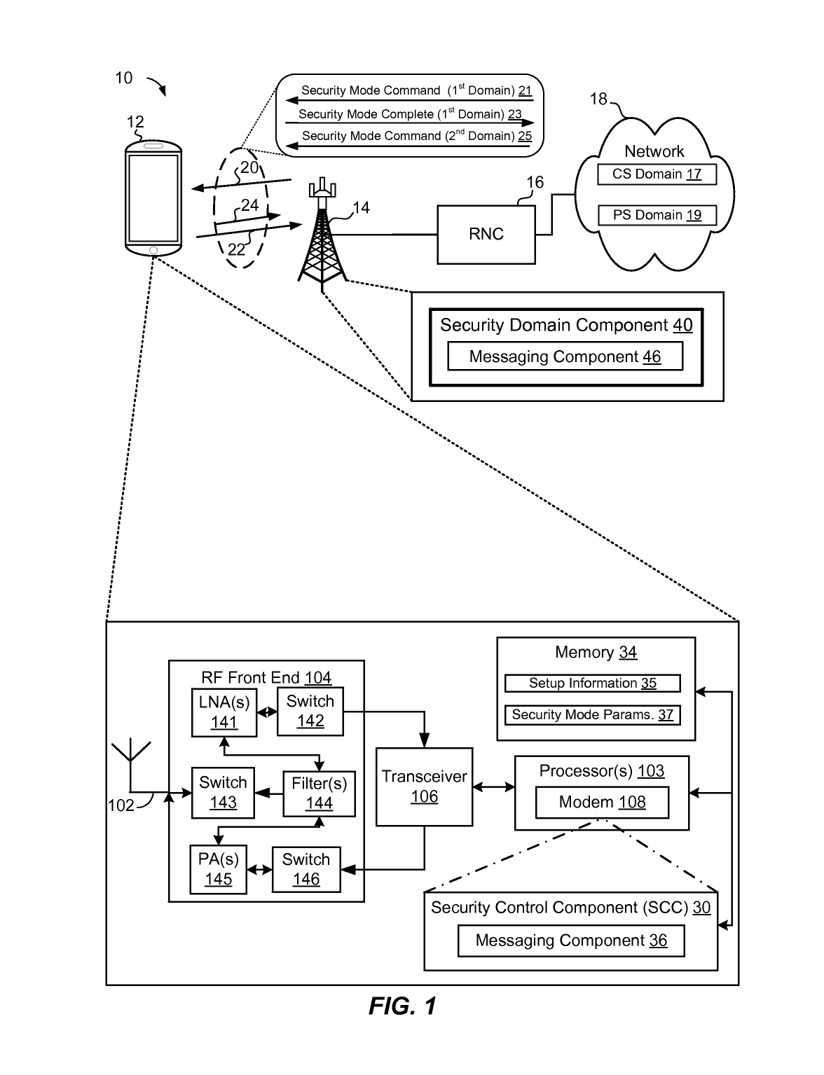

Referring to FIG. 1, in an aspect, a wireless communication system 10 includes UE 12 in communication coverage of at least one network entity 14 (e.g., a base station or node B (NodeB or NB)). UE 12 may communicate with a network 18 via network entity 14 and a radio-network controller (RNC) 16. In an aspect, network 18 can include core network domains, such as circuit-switched (CS) domain 17 and packet-switched (PS) domain 19. In an aspect, the UE 12 may have established one or more uplink channels 22 for sending control and/or data transmissions 24 to network entity 14, and one or more downlink channels 20 for receiving responses to such transmissions and/or control signaling. Uplink channels 22 and/or downlink channels 20 may include signaling bearers.

During establishment of channels 20, 22 UE 12 and network entity 14 can establish security protocols during or after setup of a radio resource control (RRC) connection. In an aspect, security procedures between UE 12 and network entity 14 can be performed after UE 12 and/or network entity 14 sends initial direct transfer messages (e.g., request service messages for the UE 12) to the other unit. In an aspect, UE 12 and/or network entity 14 can set up security procedures after the transfer of the initial direct transfer messages, but before the transmission of a UDT or DDT message (e.g., authentication messages for UE 12 and/or network entity 14, other non-access stratum (NAS) messages following the initial direct transfer message, etc.). In an aspect, UE 12 and network entity may send messages (e.g., data transmissions 24) between each other to establish the security protocols. For example, network entity 14 may send security mode command messages, including security mode command message for a first domain 21 and security mode command message for a second domain 25 via downlink channel 20. UE 12 may similarly send security mode complete message for the first domain 23 as data transmission 24 via uplink channel 24.

In an aspect, UE 12 may include one or more processors 103, which can include a modem 108 that uses one or more modem processors. The various functions related to security control component 30 may be included in modem 108 and/or processors 103 and, in an aspect, can be executed by a single processor, while in other aspects, different ones of the functions may be executed by a combination of two or more different processors. For example, in an aspect, the one or more processors 103 may include any one or any combination of a modem processor, or a baseband processor, or a digital signal processor, or a transmit processor, or a transceiver processor associated with transceiver 106. In particular, the one or more processors 103 may execute functions and components included in security control component 30, including a messaging component 36 for parsing messages associated with security procedures processed by security control component 30.

According to the present aspects, UE 12 can include a security control component (SCC) 30 that may include hardware and/or software executable by processor 103 for controlling security procedures with network entity 14. Security control component 30 can include messaging component 36 and may store data in memory 34. SCC 30 can receive security commands 21, 25 from network entity 14 and can use information included in the received commands 21, 25 to setup security measures in the specified domain via network entity 14. In an aspect, SCC 30 receives, via antenna 102, RF front end 104, and transceiver 106, information in the security mode command 21, 25 to set up integrity protection for signaling bearers; in an aspect, SCC 30 receives information in the security mode command 21, 25 to setup ciphering in all radio bearers. During operation, SCC 30 can receive a security mode command 21 from network entity 14, set up security parameters using information included in the security mode command for a first domain 21 (e.g., CS domain 17), and send a security mode complete message for the first domain 23 to network entity 14 to indicate that the security procedure was completed properly. Then, network entity 14 can signify the completion of the security procedure by sending a radio link control acknowledgement (RLC ACK) to UE 12. According to one of the present aspects, however, SCC 30 may initiate a second security mode procedure in response to receiving a second security mode command for a second domain 25 (e.g., PS domain 19), rather than waiting for the RLC ACK associated with the first security procedure. Alternatively, or in addition, SCC 30 may trigger network entity 14 to send the second security mode command for the second domain 25 by sending to network entity 14 a message that adheres to the security protocols of the first security mode procedure, thereby implying that UE 12 has completed establishment of the first security mode procedure.

In an aspect, messaging component 36 may include hardware and/or software executable by processor 103 for parsing messages to be used by SCC 30. SCC 30 can use messaging component 36 to parse messages (e.g., security mode commands 21, 25, RLC acknowledgements, etc.) associated with security procedures processed by SCC 30. In an aspect, messaging component 36 can also generate messages (e.g., security mode complete messages 23, measurement report messages) created by SCC 30 as part of its security procedures. In an aspect, SCC 30 and/or messaging component 36 can include hardware and/or software code executable by a processor for processing messages related to security procedures (e.g., integrity protection and/or ciphering) for RRC connections.

In an aspect, memory 34 can be connected to processor 103 and can store information, including, for example, setup information 35 for SCC 30 relating to security procedures. For example, SCC 30 can store security mode parameters 37 included in a received security mode command (e.g., messages commands 21, 25) in memory 34. SCC 30 can subsequently use the saved parameters 37 when generating messages that adhere to the implemented security protocols using messaging component 36. In an aspect, memory 34 can save the received security mode command 21, 25. SCC 30 can save the received security mode command 21, 25, for example, when it receives the security command 25 for one domain (e.g., a packet-switched domain) while it is processing security procedures for another domain 21 (e.g., a circuit-switched domain).

Moreover, in an aspect, UE 12 may include RF front end 104 and transceiver 106 for receiving and transmitting radio transmissions, for example, downlink channel 20 transmitted by the network entity 14. For example, transceiver 106 may receive a message by the network entity 14. Transceiver 106 may communicate with modem 108 to transmit messages generated by security control component 30 and receive messages and subsequently forward them to security control component 30.

RF front end 104 may be connected to one or more antennas 102 and can include one or more low-noise amplifiers (LNAs) 141, one or more switches 142, 143, 145, one or more power amplifiers (PAs) 145, and one or more filters 144 for transmitting and receiving RF signals on the uplink channels 173 and downlink channels 171. In an aspect, components of RF front end 104 can connect with transceiver 106. Transceiver 106 may connect to one or more modems 108 and processor 103.

In an aspect, LNA 141 can amplify a received signal at a desired output level. In an aspect, each LNA 141 may have a specified minimum and maximum gain values. In an aspect, RF front end 104 may use one or more switches 142, 143 to select a particular LNA 141 and its specified gain value based on a desired gain value for a particular application.

Further, for example, one or more PA(s) 145 may be used by RF front end 104 to amplify a signal for an RF output at a desired output power level. In an aspect, each PA 145 may have a specified minimum and maximum gain values. In an aspect, RF front end 104 may use one or more switches 143, 146 to select a particular PA 145 and its specified gain value based on a desired gain value for a particular application.

Also, for example, one or more filters 144 can be used by RF front end 104 to filter a received signal to obtain an input RF signal. Similarly, in an aspect, for example, a respective filter 144 can be used to filter an output from a respective PA 145 to produce an output signal for transmission. In an aspect, each filter 144 can be connected to a specific LNA 141 and/or PA 145. In an aspect, RF front end 104 can use one or more switches 142, 143, 146 to select a transmit or receive path using a specified filter 144, LNA, 141, and/or PA 145, based on a configuration as specified by transceiver 106 and/or processor 103.

Transceiver 106 may be configured to transmit and receive wireless signals through antenna 102 via RF front end 104. In an aspect, transceiver may be tuned to operate at specified frequencies such that UE 12 can communicate with, for example, network entity 130. In an aspect, for example, modem 108 can configure transceiver 106 to operate at a specified frequency and power level based on the UE configuration of the UE 12 and communication protocol used by modem 108.

In an aspect, modem 108 can be a multiband-multimode modem, which can process digital data and communicate with transceiver 106 such that the digital data is sent and received using transceiver 106. In an aspect, modem 108 can be multiband and be configured to support multiple frequency bands for a specific communications protocol. In an aspect, modem 108 can be multimode and be configured to support multiple operating networks and communications protocols. In an aspect, modem 108 can control one or more components of UE 12 (e.g., RF front end 104, transceiver 106) to enable transmission and/or reception of signals from the network based on a specified modem configuration. In an aspect, the modem configuration can be based on the mode of the modem and the frequency band in use. In another aspect, the modem configuration can be based on UE configuration information associated with UE 12 as provided by the network during cell selection and/or cell reselection.

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 12 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, network entity 14 can include a security domain component (SDC) 40 that may include hardware and/or software executable by a processor in the network entity for controlling security procedures with UE 12. Security domain component 40 can include messaging component 46 and may connect to memory included in the network entity. SDC 40 can send (via a transceiver, front end, and antenna) security commands 21, 245 to UE 12, which can use the information included in the commands to setup security measures in the specified domain. In an aspect, SDC 40 sends information in the security mode command 21, 25 to set up integrity protection for signaling bearers; in an aspect, SDC 40 sends information in the security mode command 21, 25 to setup ciphering in all radio bearers. During operation, SDC 40 can send a security mode command 21 to UE 12 and receive a security mode complete message 23 from UE 12, which indicates that the security procedure was completed properly. SDC 40 can signify the completion of the security procedure by sending a radio link control acknowledgement (RLC ACK) to UE 12. According to the present aspects, however, SDC 40 may cause UE 12 to initiate a second security mode procedure by sending a second security mode command 25, rather than having UE 12 wait for the RLC ACK associated with the first security procedure. Alternatively, or in addition, SDC 40 may be triggered by UE 12 to send the second security mode command 25 based on receiving a message from UE 12 that adheres to the security protocols of the first security mode procedure, thereby implying that UE 12 has completed establishment of the first security mode procedure.

In an aspect, messaging component 46 may include hardware and/or software executable by a processor in network entity 14 for parsing messages to be used by SDC 40. SDC 40 can use messaging component 46 to parse messages (e.g., security mode complete messages 23, measurement report messages) associated with security procedures processed by SDC 40. In an aspect, messaging component 46 can also generate messages (e.g., security mode commands 21, 25, RLC acknowledgements, etc.) created by SDC 40 as part of its security procedures. In an aspect, SDC 40 and/or messaging component 46 can include hardware and/or software code executable by a processor for processing messages related to security procedures (e.g., integrity protection and/or ciphering) for RRC connections. In an aspect, memory included in network entity 14 can store information, including, for example, information for SDC 40 relating to security procedures. For example, SDC 40 can store in memory security mode parameters, which are then included in security mode commands 21, 25. In an aspect, the memory can save an indication of whether an RLC acknowledgement was sent; in an aspect, the memory can save an indication of a message from UE 12 that specifies whether it received the sent RLC acknowledgement.

Further, in an aspect, network entity can include components, such as an antenna, RF front end, and transceiver that are similar to antenna 102, RF front end 104, and transceiver 106 included in UE 12. In an aspect, SDC 40 can use the antenna, RF front end, and transceiver to transmit and receive messages with UE 12.

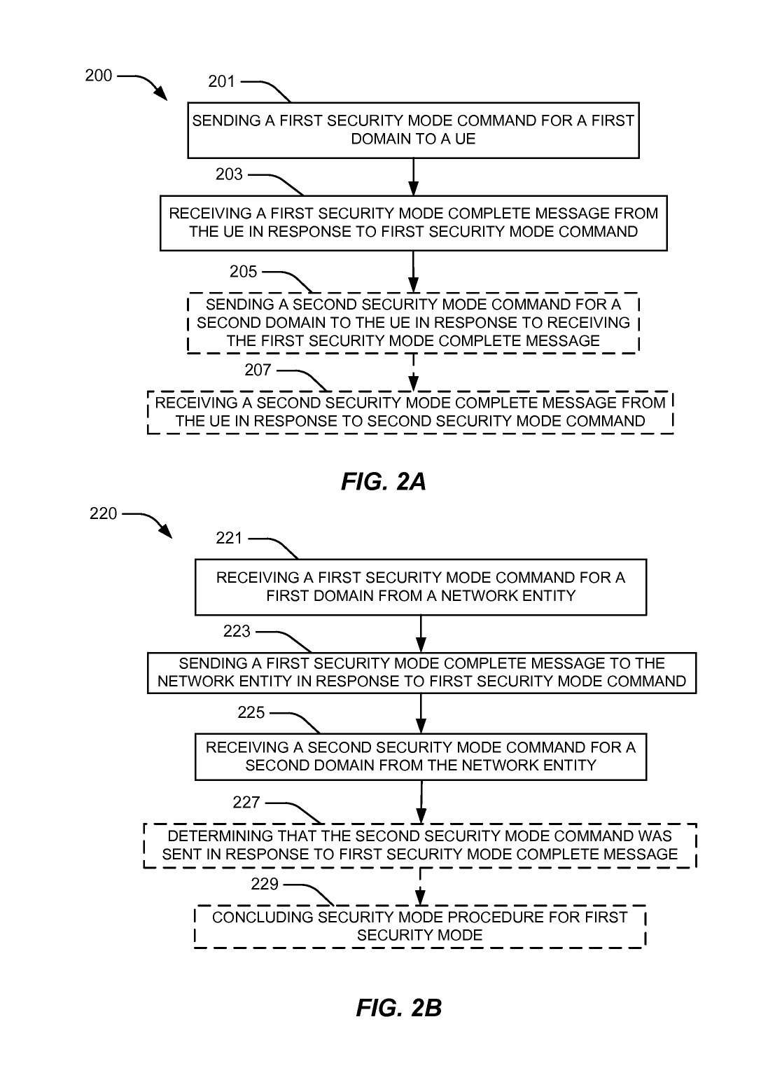

Referring to FIG. 2A, in an operational aspect, a network entity such as network entity 14 (FIG. 1) can perform one aspect of method 200 for establishing security procedures for multiple domains. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. In an aspect, method 200 can be implemented by network entity 14 executing security domain component (SDC) 40 and/or one or more of its sub-components as described herein.

Method 200 involves the network entity 14 sending a security mode command 21 to setup security for a first domain (e.g., CS domain 17) and sending a security mode command 25 to setup security for a second domain (e.g., PS domain 19). In method 200, network entity 14 can treat the received security mode complete message 23 as an indication that UE 12 completed setup for the first domain and can send a security mode command for the second domain without sending an RLC acknowledgement.

In an aspect, at block 201, the method 200 can include sending a first security mode command for a first domain to a UE. For example, in an aspect, SDC 40 of network entity 14 can use messaging component 46 to send a security mode command (SMC) 21 to UE 12 to setup security parameters (e.g., integrity protection and/or ciphering) for signaling in a domain, such as a circuit-switched (CS) domain 17 or a packet-switched (PS) domain 19. In an aspect, setup of security based on the parameters included in the sent security mode command 21 comprises an SMC procedure for a specified domain (e.g., CS domain 17). For example, setup of security parameters for the CS domain 17 can be denoted as: SMC procedure (CS domain).

At block 203, method 200 can include receiving a first security mode complete message from the UE. For example, in an aspect, SDC 40 of network entity 14 can receive a security mode complete message 23 from UE 12 in response to the security mode command 21 sent to the UE 12 at block 201. In an aspect, the security mode complete message 23 from UE 12 can indicate that UE 12 successfully processed the setup of the security procedure for the first domain.

At block 205, method 200 can optionally include sending a second security mode command for a second domain to the UE in response to receiving the a first security mode complete message. For example, in an aspect, SDC 40 of network entity 14 can send a second security mode command 25 for a second domain to UE 12 upon receipt of the first security mode complete message 23 from UE 12 at block 203. In an aspect, SDC 40 can send the security mode command 25 for a different domain, such as PS domain 19. In an aspect, network entity 14 can refrain from sending an RLC acknowledgement. In such instances, UE 12 can treat the receipt of the second SMC 25 as the equivalent of a receipt of an RLC acknowledgement and act in a similar manner, ending the security procedure associated with the first domain. In an aspect, the second security mode command 25 can be packaged using security parameters (e.g., ciphering) associated with the first security mode command 21.

At block 207, method 200 can optionally include receiving a second security mode complete message from the UE. For example, in an aspect, network entity 14 can receive a security mode complete message associated with the second domain from UE 12, which may be sent in response to reception of the first security mode complete message 23. The reception of the second security mode complete message 23 can indicate that UE 12 successfully completed the security procedure associated with the second domain.

Referring to FIG. 2B, in an operational aspect, user equipment like UE 12 (FIG. 1) can perform one aspect of method 220 for establishing security procedures for multiple domains. In an aspect, method 220 can be implemented by UE 12 executing security control component (SCC) 30 and/or one or more of its sub-components as described herein.

Method 220 involves the UE 12 setting up security for a first domain in response to a received first security mode command and setting up security for a second domain in response to a received second security mode command. In method 220, UE 12 can send a security mode complete message 23 to indicate that it completed setup for the first domain and can determine that the security mode command for the second domain 25 is equivalent to the network entity 14 sending a RLC acknowledgement.

In an aspect, at block 221, the method 220 can include receiving a first security mode command for a first domain from a network entity. For example, in an aspect, SCC 30 of UE 12 can use messaging component 36 to receive a security mode command (SMC) 21 from network entity 14 to setup security parameters (e.g., integrity protection and/or ciphering) for signaling in a domain, such as a circuit-switched (CS) domain 17 or a packet-switched (PS) domain 19. In an aspect, setup of security based on the parameters included in the received security mode command 21 comprises an SMC procedure for a specified domain.

At block 223, method 220 can include sending a first security mode complete message to the network entity in response to the first security mode command. For example, in an aspect, SCC 30 of UE 12 can send a security mode complete message 23 to network entity 14 in response to the security mode command 21 received from network entity 14 at block 221. In an aspect, the security mode complete message 23 can indicate that UE 12 successfully processed the setup of the security procedure for the first domain.

At block 225, method 220 can include receiving a second security mode command for a second domain from the network entity. For example, in an aspect, SCC 30 of UE 12 can receive a second security mode command 25 for a second domain from network entity 14 that was sent in response to the first security mode complete message 23 at block 223. In an aspect, SCC 30 can receive the security mode command 25 for a different domain, such as a packet-switched (PS) domain 19. In an aspect, the second security mode command 25 may have been packaged using security parameters (e.g., ciphering) associated with the first security mode command 21.

At block 227, method 220 can optionally include determining that the second security mode command was sent in response to the network entity's receipt of the first security mode complete message. For example, in an aspect, SCC 30 can receive a second security mode command 25 from network entity 14. The reception of the first security mode complete message by the network entity 14 can indicate to the network entity 14 that UE 12 successfully completed the security procedure associated with the first domain. Network entity 14 can send a second security mode command 25 that is associated with the second domain to the UE 12. UE 12 can determine that the network entity 14 sent the second security mode command 25 in response to a reception of the first security mode complete message 23.

At block 229, method 220 can optionally include concluding the security mode procedure for the first security mode. In an aspect, SCC 30 can interpret the receipt of the second security mode command from the second domain 25 from network entity 14 as the equivalent of an RLC ACK message. For example, SCC 30 can conclude the security procedure for the first domain upon receipt of message that is the equivalent of an RLC ACK. In an aspect, SCC 30 can perform block 229 before performing block 227 of method 220.

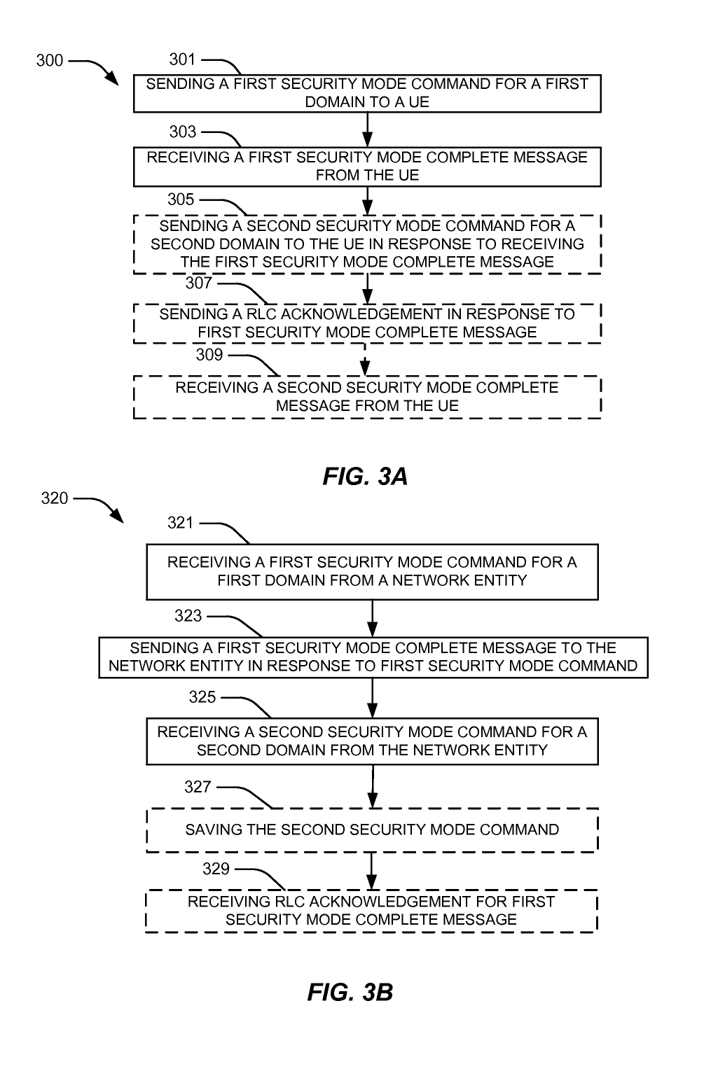

Referring to FIG. 3A, in an operational aspect, a network entity, such as network entity 14 (FIG. 1) can perform one aspect of method 300 for establishing security procedures for multiple domains. Method 300 involves network entity 14 sending a security mode command to setup security for a first domain and sending a security mode command to setup security for a second domain. In method 300, network entity 14 can treat the received security mode complete message 23 as an indication that UE 12 completed setup for the first domain and can send a security mode command for the second domain 25 while sending an RLC acknowledgement. The UE 12 can store the second security mode command 25 until it receives the RLC acknowledgement and can begin security procedures for the second domain from the saved security mode command for the second domain 25 once the security procedures for the first domain conclude, which can be upon the receipt of the RLC acknowledgement.

In an aspect, at block 301, the method 300 can include sending a first security mode command for a first domain to a UE. For example, in an aspect, SDC 40 of network entity 14 can use messaging component 46 to send a security mode command (SMC) 21 to UE 12 to setup security parameters (e.g., integrity protection and/or ciphering) for signaling in a domain, such as a circuit-switched (CS) domain 17 or a packet-switched (PS) domain 19. In an aspect, setup of security based on the parameters included in the sent security mode command 21 comprises an SMC procedure for a specified domain (e.g., CS domain 17).

At block 303, method 300 can include receiving a first security mode complete message from the UE. For example, in an aspect, SDC 40 of network entity 14 can receive a security mode complete message 23 from UE 12 in response to the security mode command 21 sent to the UE 12 at block 201. In an aspect, the security mode complete message 23 from UE 12 can indicate that UE 12 successfully processed the setup of the security procedure for the first domain.

At block 305, method 300 can optionally include sending a second security mode command for a second domain to the UE in response to receiving the first security mode complete message. For example, in an aspect, SDC 40 of network entity 14 can send a second security mode command 25 for a second domain to UE 12 upon receipt of the first security mode complete message 23 from UE 12 at block 303. In an aspect, SDC 40 can send the security mode command 25 for a different domain, such as a packet-switched (PS) domain 19. In an aspect, the second security mode command 25 can be packaged using security parameters (e.g., ciphering) associated with the first security mode command 21.

At block 307, method 300 can optionally include sending a RLC acknowledgement in response to first security mode complete message. For example, in an aspect, network entity 14 can send an RLC acknowledgement to UE 12 to indicate it has received the security mode complete message 23. In an aspect, RLC acknowledgement can indicate that the security procedure relating to the first domain has concluded.

At block 309, method 300 can optionally include receiving a second security mode complete message from the UE 12. For example, in an aspect, network entity 14 can receive a security mode complete message associated with the second domain from UE 12, which was sent in response to receiving the RLC acknowledgement in block 307. The reception of the second security mode complete message can indicate that UE 12 successfully completed the security procedure associated with the second domain.

Referring to FIG. 3B, in an operational aspect, user equipment like UE 12 (FIG. 1) can perform one aspect of method 320 for establishing security procedures for multiple domains. In an aspect, method 320 can be implemented by UE 12 executing security control component (SCC) 30 and/or one or more of its sub-components, as described herein.

Method 320 involves the UE 12 setting up security for a first domain in response to a received first security mode command and setting up security for a second domain in response to a received second security mode command. In method 320, UE 12 can send a security mode complete message 23 to indicate that it completed setup for the first domain and can save the security mode command for the second domain 25 until it receives a RLC acknowledgement from the network entity in response to the first security mode complete message 23.

In an aspect, at block 321, the method 320 can include receiving a first security mode command for a first domain from a network entity. For example, in an aspect, SCC 30 of UE 12 can use messaging component 36 to receive a security mode command (SMC) 21 from network entity 14 to setup security parameters (e.g., integrity protection and/or ciphering) for signaling in a domain, such as a circuit-switched (CS) domain 17 or a packet-switched (PS) domain 19. In an aspect, setup of security based on the parameters included in the received security mode command 21 comprises an SMC procedure for a specified domain.

At block 323, method 320 can include sending a first security mode complete message to the network entity. For example, in an aspect, SCC 30 of UE 12 can send a security mode complete message 23 to network entity 14 in response to the security mode command 21 received from network entity 14 at block 321. In an aspect, the security mode complete message 23 can indicate that UE 12 successfully processed the setup of the security procedure for the first domain.

At block 325, method 320 can include receiving a second security mode command for a second domain 25 from the network entity. For example, in an aspect, SCC 30 of UE 12 can receive a second security mode command for a second domain 25 from network entity 14 that was sent in response to the first security mode complete message 23 at block 323. In an aspect, SCC 30 can receive the security mode command 25 for a different domain, such as a packet-switched (PS) domain 19. In an aspect, the second security mode command 25 may have been packaged using security parameters (e.g., ciphering) associated with the first security mode command 21.

At block 327, method 320 can optionally include saving the second security mode command. For example, in an aspect, SCC 30 of UE 12 can save the second security mode command 21 received at block 325 in memory 34 (e.g., saving the parameters included in security mode command 21 as security mode parameters 37 or saving the command 25 as setup information 35).

At block 329, method 320 can optionally include receiving a RLC acknowledgement in response to first security mode complete message. For example, in an aspect, UE 12 can receive a RLC acknowledgement from network entity 14 that indicates it has received the security mode complete message 23. In an aspect, RLC acknowledgement can indicate that the security procedure relating to the first domain has concluded. In an aspect, UE 12 can optionally begin security procedures as soon as it concludes security procedures relating to the first domain. In such instances, SCC 30 can use the second security mode command 25 stored in memory 34 (e.g., data stored in setup information 35 or security mode parameters 37) to start processing security procedures for the second domain.

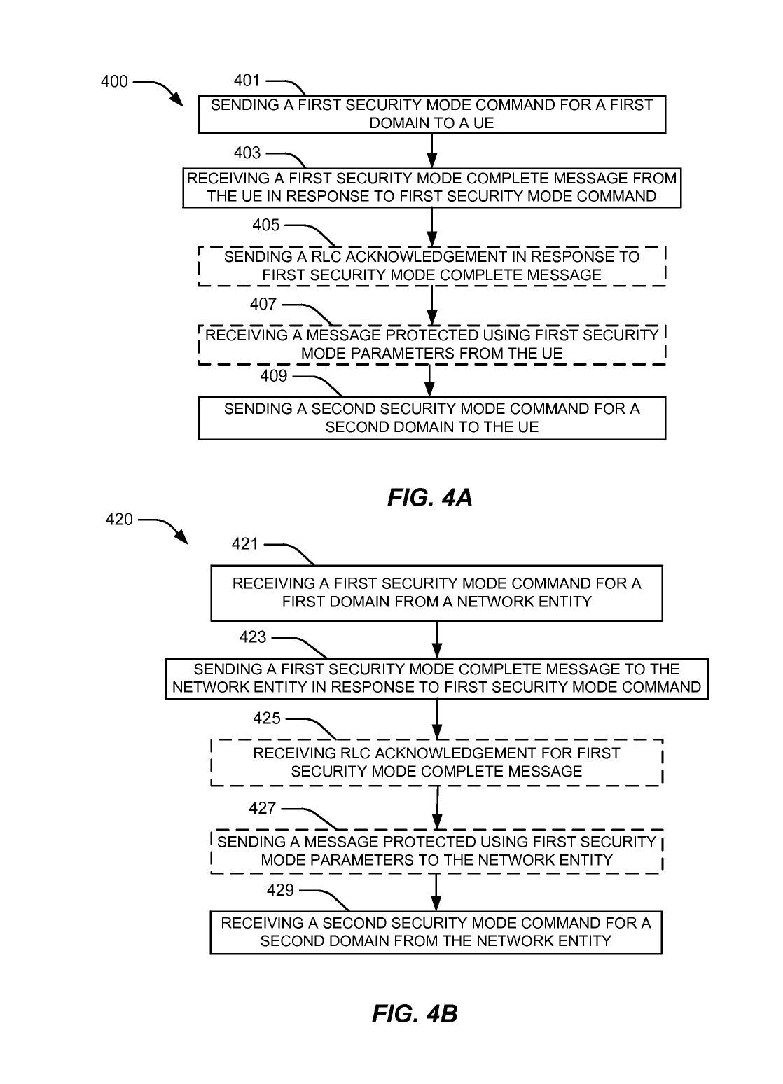

Referring to FIG. 4A, in an operational aspect, a network entity, such as network entity 14 (FIG. 1) can perform one aspect of method 400 for establishing security procedures form multiple domains. Method 400 involves network entity 14 sending a security mode command 21 to setup security for a first domain and sending a security mode command 25 to setup security for a second domain. In method 400, network entity 14 can send an RLC acknowledgement to UE 12 in response to a received security mode complete message 23. Network entity 14 can receive a message, such as a measurement report, from UE 12, that includes security parameters based on the correct completion of the security procedures for the first domain. Network entity 14 can interpret the receipt of a message with proper security parameters as an indication that UE 12 received the RLC acknowledgement and can send a second security mode command for a second domain 25 for the UE 12 to perform security procedures for the second domain.

In an aspect, at block 401, the method 400 can include sending a first security mode command for a first domain to a UE. For example, in an aspect, SDC 40 of network entity 14 can use messaging component 46 to send a security mode command (SMC) 21 to UE 12 to setup security parameters (e.g., integrity protection and/or ciphering) for signaling in a domain, such as a circuit-switched (CS) domain 17 or a packet-switched (PS) domain 19. In an aspect, setup of security based on the parameters included in the sent security mode command 21 comprises an SMC procedure for a specified domain (e.g., CS domain 19).

At block 403, method 400 can include receiving a first security mode complete message from the UE. For example, in an aspect, SDC 40 of network entity 14 can receive a security mode complete message 23 from UE 12 in response to the security mode command 21 sent to the UE 12 at block 401. In an aspect, the security mode complete message 23 from UE 12 can indicate that UE 12 successfully processed the setup of the security procedure for the first domain.

At block 405, method 400 can optionally include sending a RLC acknowledgement in response to first security mode complete message. For example, in an aspect, SDC 40 of network entity 14 can use messaging component 46 to send an RLC ACK to UE 12 to indicate it has received the security mode complete message 23. In an aspect, the RLC acknowledgement can indicate that the security procedure relating to the first domain has concluded.

At block 407, method 400 can optionally include receiving a message protected using first security mode parameters from the UE. For example, in an aspect, SDC 40 of network entity 14 can use messaging component 46 can receive and parse a message sent from UE 12. In an aspect, the message received from the UE 12 can include protection that is configured using the parameters associated with the first security mode command 21 sent in block 401. For example, UE 12 can send a “dummy” message, such as a blank measurement report, that is packaged using the integrity protection security parameters configured from the first received security mode command 21.

At block 409, method 400 can include sending a second security mode command for a second domain to the UE. For example, in an aspect, SDC 40 of network entity 14 can send a second security mode command for a second domain 25 to UE 12 upon receipt of the message including the configured security parameters from UE 12 at block 407. In an aspect, SDC 40 can send the security mode command 25 for a different domain, such as a packet-switched (PS) domain 19. In an aspect, the second security mode command 25 can be packaged using security parameters (e.g., ciphering) associated with the first security mode command 21.

Referring to FIG. 4B, in an operational aspect, user equipment like UE 12 (FIG. 1) can perform one aspect of method 420 for establishing security procedures for multiple domains. In an aspect, method 420 can be implemented by UE 12 executing security control component (SCC) 30 and/or one or more of its sub-components, as described herein.

Method 420 involves the UE 12 setting up security for a first domain in response to a received first security mode command and setting up security for a second domain in response to a second security mode command. In method 420, UE 12 can send a security mode complete message 23 to indicate that it completed setup for the first domain (e.g., CS domain 17). Upon receipt of an RLC acknowledgement from the network entity 14, UE 12 can generate and send a message, such as a measurement report, that includes security parameters based on the completion of the security procedures for the first domain. UE 12 can subsequently receive a second security mode command for a second domain 25 in response to the message sent using the configured security parameters.

In an aspect, at block 421, the method 420 can include receiving a first security mode command for a first domain from a network entity. For example, in an aspect, SCC 30 of UE 12 can use messaging component 36 to receive a security mode command (SMC) 21 from network entity 14 to setup security parameters (e.g., integrity protection and/or ciphering) for signaling in a domain, such as a circuit-switched (CS) domain 17 or a packet-switched (PS) domain 19. In an aspect, setup of security based on the parameters included in the received security mode command 21 comprises an SMC procedure for a specified domain.

At block 423, method 420 can include sending a first security mode complete message to the network entity. For example, in an aspect, SCC 30 of UE 12 can send a security mode complete message 23 to network entity 14 in response to the security mode command 21 received from network entity 14 at block 421. In an aspect, the security mode complete message 23 can indicate that UE 12 successfully processed the setup of the security procedure for the first domain.

At block 425, method 420 can optionally include receiving a RLC acknowledgement in response to first security mode complete message. For example, in an aspect, SCC 30 of UE 12 can use messaging component 36 to receive an RLC ACK from network entity 14 to indicate it has received the security mode complete message 23. In an aspect, the RLC acknowledgement can indicate that the security procedure relating to the first domain has concluded.

At block 427, method 420 can optionally include sending a message protected using first security mode parameters to the network entity. For example, in an aspect, SCC 30 of UE 12 can use messaging component 36 can generate and send a message that is sent to network entity 14. In an aspect, the message can include protection that is configured using the parameters associated with the first security mode command 21 received in block 421. For example, messaging component 36 of SCC 30 in UE 12 can generate and send a “dummy” message, such as a blank measurement report, that is packaged using the integrity protection security parameters configured from the first received security mode command 21.

At block 429, method 420 can include receiving a second security mode command for a second domain from the network entity. For example, in an aspect, SCC 30 of UE 12 can receive a second security mode command for a second domain 25 from network entity 14 in response to the sent message that included the configured security parameters at block 427. In an aspect, SCC 30 of UE 12 can receive the security mode command 25 for a different domain, such as a packet-switched (PS) domain 19. In an aspect, the second security mode command 25 may have been packaged using security parameters (e.g., ciphering) associated with the first security mode command 21.

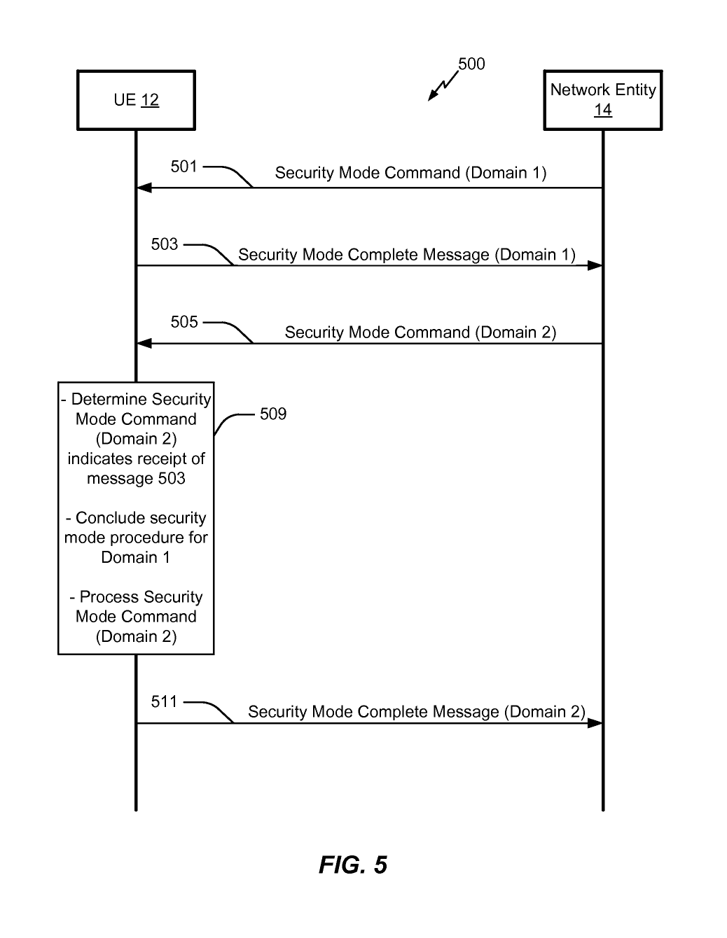

FIG. 5 is a signaling diagram describing the flow of messages between devices and device components in accordance with an aspect of the present disclosure. For example, in an aspect, diagram 500 illustrates messages sent between UE 12 and network entity 14 to set up security parameters for UE 12 for signaling in multiple domains.

Network entity 14 can send message 501, such as a security mode command for a first domain (e.g., Domain 1, CS domain 17), to UE 12. UE 12 can send message 503, such as a security mode complete message for the first domain, to network entity 14. In an aspect, network entity 14 can interpret the reception of security mode complete message 503 as an indication that UE 12 completed its security procedure for the first domain.

In an aspect, upon determining that UE 12 has completed its security procedures for the first domain based on receiving security mode complete message 503, network entity 14 can send message 505, such as a security mode command for a second domain (e.g., Domain 2, PS domain 19) to UE 12. In an aspect, network entity 14 can send security mode command 505 to UE 12 in lieu of sending a separate RLC acknowledgement message.

At block 509, UE 12 can determine that the security mode command 505 that is received while waiting for the RLC ACK of message 503 indicates that network entity 14 has received message 503. In response, UE 12 may conclude security mode procedure for Domain 1, and also may process message 505 (Security Mode Command (Domain 2)). In other words, in an aspect, when security mode command 505 (Security Mode Command (Domain 2)) is received while waiting for the RLC ACK of message 503 (Security Mode Complete Message (Domain 1)), UE 12 may act as if an RLC ACK is received from network entity 14. For example, in an aspect, network entity 14 can send security mode command 505 in lieu of an RLC ACK. In such instances, UE 12 can interpret the receipt of security mode command 505 for the second domain as being equivalent to receipt of the RLC ACK response to the security mode complete message 503. As such, UE 12 can respond to the equivalent of the reception of an RLC ACK, e.g., message 505 (Security Mode Command (Domain 2)), by concluding security operations relating to the first domain. Additionally, as noted, UE 12 can begin security operations for the received security mode command 505 upon receipt when waiting for the RLC ACK of message 503. In an aspect, the security operations for the second domain can be similar to the security operations for the first domain.

Upon successful setup of security parameters relating to the second security mode command (and the second domain), UE 12 can send message 511, which can be a security mode complete message for the second domain, to network entity 14.

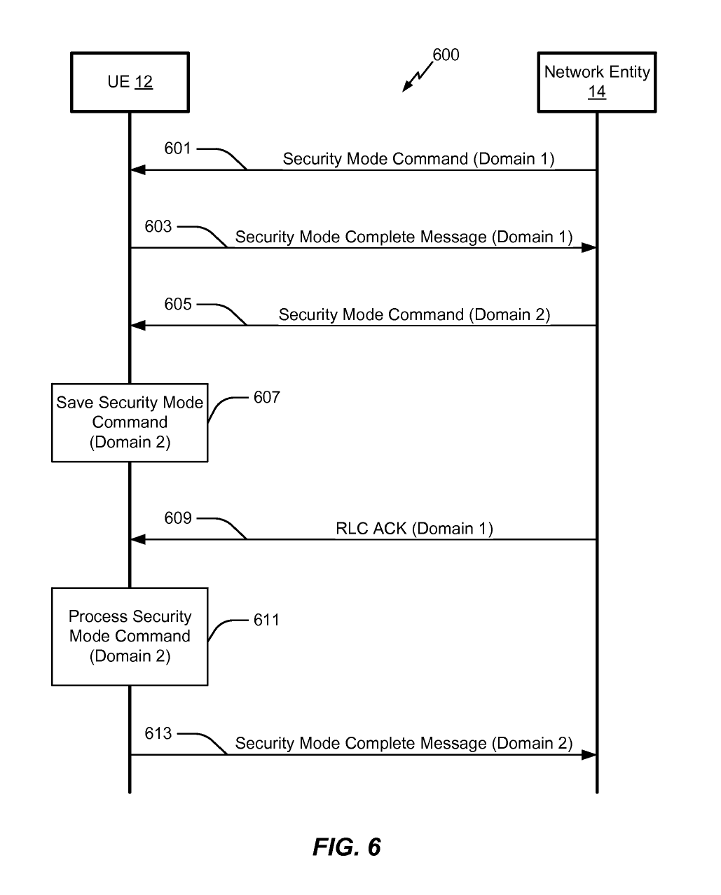

FIG. 6 is a signaling diagram describing the flow of messages between devices and device components in accordance with an aspect of the present disclosure. For example, in an aspect, diagram 600 illustrates messages sent between UE 12 and network entity 14 to set up security parameters for UE 12 for signaling in multiple domains.

Network entity 14 can send message 601, such as a security mode command for a first domain (e.g., Domain 1, CS domain 17), to UE 12. UE 12 can send message 603, such as a security mode complete message for the first domain, to network entity 14. In an aspect, network entity 14 can interpret the reception of security mode complete message 603 as an indication that UE 12 completed its security procedure for the first domain. In an aspect, upon determining that UE 12 has completed its security procedures for the first domain, network entity 14 can send message 605, such as a security mode command for a second domain (e.g., Domain 2, PS domain 19) to UE 12. It is noted that, up to this point, the methodology of diagram 600 may be similar to that of diagram 500.

At block 607, UE 12 can save the received security mode command 605. For example, in an aspect, SCC 30 of UE 12 can save the security mode command 605 in memory 34. In such instances, UE 12 can save security mode command 605 for the second domain until it receives the RLC ACK response to the security mode complete message 603 sent by UE 12.

In an aspect, network entity 14 can send message 609, such as an RLC ACK message, to UE 12. In an aspect, network entity 14 can send RLC ACK 609 before second security mode command 605. In such instances, UE 12 can receive RLC ACK message 609 after receipt of second SMC 605. In an aspect, UE 12 can respond to the reception of RLC ACK 609 by concluding security operations relating to the first domain.

In an aspect, at 611, UE 12 can begin security operations for the saved security mode command 605 for the second command by initiating processing of security mode command 605 in response to receiving RLC ACK 609. In an aspect, the security operations for the second domain can be similar to the security operations for the first domain. Upon successful setup of security parameters relating to the second security mode command (and the second domain), UE 12 can send message 613, which can be a security mode complete message for the second domain, to network entity 14.

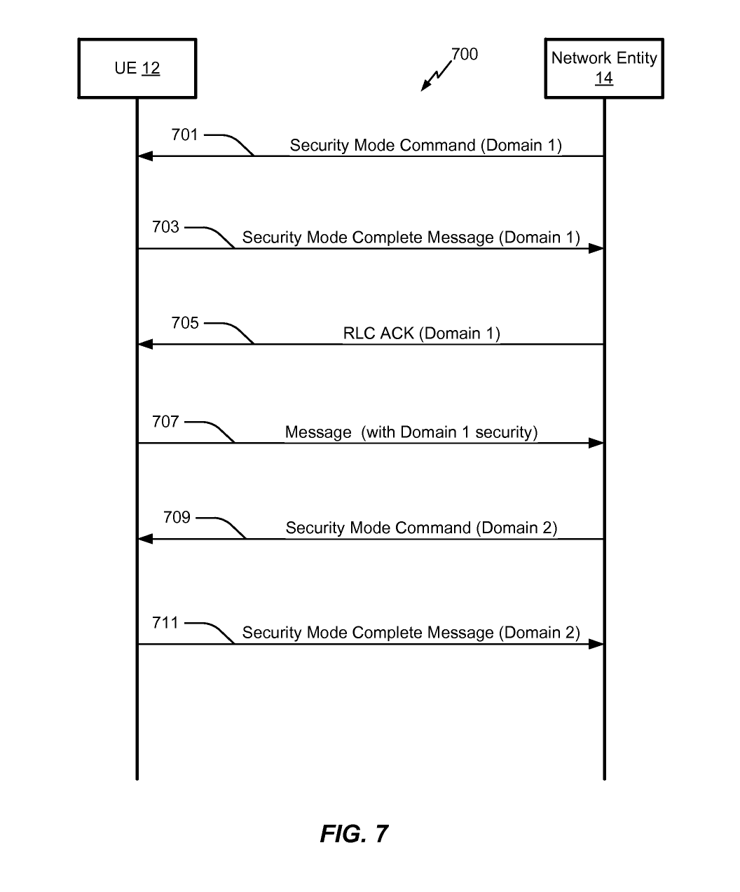

FIG. 7 is a signaling diagram describing the flow of messages between devices and device components in accordance with an aspect of the present disclosure. For example, in an aspect, diagram 700 illustrates messages sent between UE 12 and network entity 14 to set up security parameters for UE 12 for signaling in multiple domains.

Network entity 14 can send message 701, such as a security mode command for a first domain (e.g., Domain 1, CS domain 17), to UE 12. UE 12 can send message 703, such as a security mode complete message for the first domain, to network entity 14. In an aspect, as in diagrams 500 and 600, network entity 14 can interpret the reception of security mode complete message 703 as an indication that UE 12 completed its security procedure for the first domain. In an aspect, network entity 14 can send message 705, such as an RLC ACK message, to UE 12. In an aspect, UE 12 can respond to the reception of RLC ACK 609 by concluding security operations relating to the first domain.

In an aspect, UE 12 can send a message 707 according to Domain 1 security, to network entity 14. For instance, message 707 may include, but is not limited to, a measurement report message (although it does not have to include all data of a normal measurement report message) having Domain 1 security procedures and/or parameters applied to it. For example, in an aspect, SCC 30 of UE 12 can use messaging component 36 can generate and send a message that is sent to network entity 14. In an aspect, the message can include protection that is configured using the parameters associated with the first security mode command 701. For example, messaging component 36 of SCC 30 in UE 12 can generate and send a “dummy” message, such as a blank or value-less measurement report, that is packaged using the integrity protection security parameters configured from the first received security mode command 701. In an aspect, network entity 14 can interpret the receipt of message 707 including the protection using the security parameters from security mode command 701 as an indication that UE 12 received RLC ACK 705. In an aspect, network entity 14 can interpret the receipt of RLC ACK by UE 12 such that UE 12 has completed its security procedures for the first domain.

In an aspect, upon determining that UE 12 has completed its security procedures for the first domain, network entity 14 can send message 709, such as a security mode command for a second domain (e.g., Domain 2, PS domain 19) to UE 12. In an aspect, the security operations for the second domain can be similar to the security operations for the first domain. Upon successful setup of security parameters relating to the second security mode command (and the second domain), UE 12 can send message 711, which can be a security mode complete message for the second domain, to network entity 14.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f), unless the element is expressly recited using the phrase “means for” or, in the case of a method claim, the element is recited using the phrase “step for.”

What is claimed is:

1. A method of implementing a security mode configuration in a wireless system, the method comprising:
sending, by a network entity in the wireless system to a user equipment (UE), a first security mode command for a first domain;
receiving, a first security mode complete message sent from the UE in response to the first security mode command; and
sending, to the UE, a second security mode command for a second domain.

2. The method of claim 1, wherein the second security mode command is sent before a first Radio Link Control (RLC) acknowledgement associated with the first security mode complete message is received by the UE, or wherein the method further comprises refraining from sending the first RLC acknowledgement to the UE.

3. The method of claim 1, wherein at least one of the first domain or the second domain comprises a circuit-switched (CS) domain.

4. The method of claim 1, wherein at least one of the first domain or the second domain comprises a packet-switched (PS) domain.

5. The method of claim 1, wherein the second security mode command for the second domain is sent in response to receiving the first security mode complete message.

6. The method of claim 1, further comprising:
sending a first RLC acknowledgement in response to the first security mode command; and
receiving, from the UE, a message protected with first security procedure parameters associated with the first domain,
wherein the second security mode command for the second domain is sent in response to receiving the message protected with the first security procedure parameters.

7. The method of claim 6, wherein the message protected with first security procedure parameters associated with the first domain comprises:
a measurement report, the measurement report generated based upon the receipt of the RLC acknowledgement.

8. A method of implementing a security mode configuration in a wireless system, the method comprising:
receiving, by a user equipment (UE), a first security mode command for a first domain sent by a network entity in the wireless system;
sending, to the network entity, a first security mode complete message in response to receiving the first security mode command; and
receiving a second security mode command for a second domain.

9. The method of claim 8, wherein the second security mode command is received before receiving a first Radio Link Control (RLC) acknowledgement associated with the first security mode complete message, or wherein the first RLC acknowledgement is not received.

10. The method of claim 9, further comprising:
concluding a first security mode procedure for the first domain, the conclusion of the first security mode procedure based upon reception of the second security mode command.

11. The method of claim 8, further comprising:
saving, by the UE, the second security mode command;
receiving a first Radio Link Control (RLC) acknowledgement sent by the network entity in response to the first security mode complete message; and
processing, by the UE, the second security mode command after receiving the first RLC acknowledgement.

12. The method of claim 8, wherein the second security mode command for the second domain is received in response to the sending of the first security mode complete message.

13. The method of claim 8, further comprising:
receiving, at the UE, a first RLC acknowledgement associated with the first security mode complete message; and
sending, from the UE, a message protected with first security procedure parameters associated with the first domain,
wherein the second security mode command for the second domain is received from the network in response to the message protected with the first security procedure parameters.

14. The method of claim 13, wherein the message protected with the first security procedure parameters associated with the first domain comprises:
a measurement report, the measurement report generated based upon the receipt of the RLC acknowledgement.

15. An apparatus for implementing a security mode configuration in a wireless system, the apparatus comprising:
at least one processor;
a receiver configured to receive messages;
a transmitter configured to send messages;
a memory; and
a bus coupled to the at least one processor, receiver, transmitter, and memory, wherein the at least one processor is configured to:
send to a user equipment (UE) a first security mode command for a first domain,
receive a first security mode complete message sent from the UE in response to the first security mode command, and
send a second security mode command for a second domain.

16. The apparatus of claim 15, wherein the at least one processor is further configured to:
send the second security mode command before a first Radio Link Control (RLC) acknowledgement associated with the first security mode complete message is received by the UE; or
refrain from sending the first RLC acknowledgement to the UE.

17. The apparatus of claim 15, wherein at least one of the first domain or the second domain comprises a circuit-switched (CS) domain.

18. The apparatus of claim 15, wherein at least one of the first domain or the second domain comprises a packet-switched (PS) domain.

19. The apparatus of claim 15, wherein the at least one processor is further configured to send the second security mode command for the second domain in response to receiving the first security mode complete message.

20. The apparatus of claim 15, wherein the at least one processor is further configured to:
send a first RLC acknowledgement in response to the first security mode complete message;
receive a message protected with first security procedure parameters associated with the first domain from the UE; and
send the second security mode command for the second domain in response to receiving the message protected with the first security procedure parameters.

21. The apparatus of claim 20, wherein the message protected with first security procedure parameters associated with the first domain comprises:
a measurement report, the measurement report generated based upon the receipt of the RLC acknowledgement.

22. An apparatus for implementing a security mode configuration in a wireless system, the apparatus comprising:
at least one processor;
a received configured to receive messages;
a transmitter configured to send messages;
a memory; and
a bus coupled to the at least one processor, receiver, transmitter, and memory, wherein the at least one processor is configured to:
receive, via the receiver, a first security mode command for a first domain sent by a network entity in the wireless system;
send, via the transmitter, a first security mode complete message to the network entity in response to receiving the first security mode command, and
receive, via the receiver, a second security mode command for a second domain.

23. The apparatus of claim 22, wherein the at least one processor is further configured to receive the second security mode command before receiving a first RLC acknowledgement associated with the first security mode complete message; or wherein the processor does not receive the first RLC acknowledgement.

24. The apparatus of claim 23, wherein the at least one processor is further configured to:
conclude a first security mode procedure for the first domain, the conclusion of the first security mode procedure based upon reception of the second security mode command.

25. The apparatus of claim 22, wherein the at least one processor is further configured to:
save the second security mode command in the memory;
receive a first RLC acknowledgement sent by the network entity in response to the first security mode complete message; and
process the second security mode command after receiving to first RLC acknowledgement.

26. The apparatus of claim 22, wherein the at least one processor is further configured to:
receive the second security mode command for the second domain in response to the sending of the first security mode complete message.

27. The apparatus of claim 22, wherein the at least one processor is further configured to:
receive a first RLC acknowledgement associated with the first security mode complete message; and
send a message protected with first security procedure parameters associated with the first domain,
wherein the second security mode command for the second domain is received from the network entity in response to the message protected with the first security procedure parameters.

28. The apparatus of claim 27, wherein the message protected with the first security procedure parameters associated with the first domain comprises:
a measurement report, the measurement report generated based upon the receipt of the RLC acknowledgement.
